(19) United States
(12) Patent Application Publication
(10) Pub. No.: US 2025/0149758 A1
(43) Pub. Date: May 8, 2025

(54) BATTERY CELL INCLUDING INTERNAL TERMINAL LASER-WELDED TO FOLDED EXTERNAL CONNECTOR TABS

(71) Applicant: GM GLOBAL TECHNOLOGY OPERATIONS LLC, Detroit, MI (US)

(72) Inventors: Masoud MOHAMMADPOUR, Novi, MI (US); Junjie MA, Novi, MI (US); Hui-ping WANG, Troy, MI (US); Teresa Jean RINKER, Royal Oak, MI (US); Vincent Edward HERRMAN, Clawson, MI (US)

(21) Appl. No.: 18/386,849

(22) Filed: Nov. 3, 2023

(51) Int. Cl. H01M 50/566; H01M 10/04; H01M 50/533

(52) U.S. Cl. CPC H01M 50/566; H01M 10/0431; H01M 50/533; H01M 2220/20

(57) ABSTRACT

A battery cell including a stack and a first internal terminal. The stack includes: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators, where C, A, and S are integers greater than one. Each one of the external connectors, of one of the C cathode electrodes and the A anode electrodes, includes a first tab and a second tab extending farther than the first tab, the second tabs are folded onto the first tabs, and the first internal terminal is laser welded onto the second tabs.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including internal terminals laser-welded to folded external connector tabs.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

The present disclosure includes, in various features, a battery cell including a stack and a first internal terminal. The stack includes: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators, where C, A, and S are integers greater than one. Each one of the external connectors, of one of the C cathode electrodes and the A anode electrodes, includes a first tab and a second tab extending farther than the first tab, the second tabs are folded onto the first tabs, and the first internal terminal is laser welded onto the second tabs.

In further features, N of the second tabs are folded onto R of the first tabs, N and R are integers with N being equal to or greater than R.

In further features, the first tabs are folded towards the second tabs.

In further features, each one of the second tabs has a maximum length that is less than, or equal to, half of a width of the stack.

In further features, a first group of the first tabs is adjacent to a first group of the second tabs, the first group of the second tabs is folded in a first direction onto the first group of the first tabs; and a second group of the first tabs is adjacent to a second group of the second tabs, the second group of the second tabs is folded in a second direction onto the second group of the first tabs, the second direction is opposite to the first direction.

In further features, the first group of the first tabs is laterally spaced apart from, and aligned with, the second group of the second tabs in a third direction that is perpendicular to both the first direction and the second direction; and the first group of the second tabs is laterally spaced apart from, and aligned with, the second group of the first tabs in the third direction.

In further features, each one of the external connectors, of the other one of the C cathode electrodes and the A anode electrodes, includes a third tab and a fourth tab that is longer than the third tab, the fourth tabs are folded onto the third tabs, and a second internal terminal is laser welded onto the fourth tabs.

In further features, a first group of the third tabs is adjacent to a first group of the fourth tabs, the first group of the fourth tabs is folded in a first direction onto the first group of the third tabs; and a second group of the third tabs faces a second group of the fourth tabs, the second group of the fourth tabs is folded in a second direction onto the second group of the third tabs, the second direction is opposite to the first direction.

In further features, the first internal terminal and the second internal terminal are on opposite ends of the stack.

In further features, the battery cell includes: an enclosure; a first external terminal in contact with the first internal terminal; and a second external terminal in contact with the second internal terminal.

The present disclosure includes, in various features, a battery cell including a stack and a first internal terminal. The stack includes: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators, where C, A, and S are integers greater than one. With respect to one of the C cathode electrodes and the A anode electrodes, the external connectors include: a plurality of first tabs and a plurality of second tabs extending farther than the plurality of first tabs; a first group of the plurality of first tabs and a first group of the plurality of second tabs that is folded in a first direction onto the first group of the plurality of first tabs; a second group of the plurality of first tabs and a second group of the plurality of second tabs that is folded in a second direction onto the second group of the plurality of first tabs, the second direction is opposite to the first direction; and the first internal terminal laser welded onto the first group of the plurality of second tabs and the second group of the plurality of second tabs.

In further features, the first group of the plurality of first tabs is laterally spaced apart from, and aligned with, the second group of the plurality of second tabs; and the first group of the plurality of second tabs is laterally spaced apart from, and aligned with, the second group of the plurality of first tabs.

In further features, the first group of the plurality of first tabs is folded toward the first group of the plurality of second tabs; and the second group of the plurality of first tabs is folded towards the second group of the plurality of second tabs.

In further features, with respect to the other one of the C cathode electrodes and the A anode electrodes, the external connectors include: a plurality of first tabs and a plurality of second tabs extending farther than the plurality of first tabs; a first group of the plurality of first tabs and a first group of the plurality of second tabs that is folded in a first direction onto the first group of the plurality of first tabs; a second group of the plurality of first tabs and a second group of the plurality of second tabs that is folded in a second direction onto the second group of the plurality of first tabs, the second direction is opposite to the first direction; and a second internal terminal laser welded onto the first group of the plurality of second tabs and the second group of the plurality of second tabs.

In further features, each one of the plurality of second tabs has a maximum length that is less than, or equal to, half of a width of the stack.

In various features, the present disclosure includes a method for manufacturing a battery cell. The method includes providing a stack including: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; a first group of a plurality of first tabs and a first group of a plurality of second tabs included with the external connectors of one of the C cathode electrodes and the A anode electrodes, the plurality of second tabs extending farther than the plurality of first tabs; and S separators, where C, A, and S are integers greater than one. The method further includes folding the first group of the plurality of second tabs in a first direction onto the first group of the plurality of first tabs; and laser welding a first internal terminal onto the first group of the plurality of second tabs.

In further features, the method includes folding the first group of the plurality of first tabs towards the first group of the plurality of second tabs in a second direction that is opposite to the first direction. Subsequent to, or simultaneous with, folding the first group of the plurality of first tabs in the second direction, the first group of the plurality of second tabs is folded onto the first group of the plurality of first tabs.

In further features, the method includes: providing the stack including a third group of a plurality of third tabs and a fourth group of a plurality of fourth tabs included with the external connectors of the other one of the C cathode electrodes and the A anode electrodes, the plurality of fourth tabs extending farther than the plurality of third tabs; folding the fourth group of the plurality of fourth tabs onto the third group of the plurality of third tabs; and laser welding a second internal terminal onto the fourth group of the plurality of fourth tabs.

In further features, the method includes folding the third group of the plurality of third tabs towards the fourth group. Subsequent to folding the third group towards the fourth group, the fourth group is folded onto the third group.

In further features, each one of the plurality of second tabs has a maximum length that is less than, or equal to, half of a width of the stack.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side, cross-sectional view of an exemplary battery cell;

FIG. 2 is a perspective view of an example of a prismatic battery cell including laser welded internal terminals that are in contact with external terminals according to the present disclosure;

FIG. 3 is a perspective view of an example of a prismatic battery cell including electrodes with folded external connector tabs, the internal terminals are laser welded to the folded external connector tabs in accordance with the present disclosure;

FIGS. 4A and 4B are perspective views of a stack of cathode electrodes, anode electrodes, and the external connector tabs prior to being folded and welded to the internal terminals;

FIGS. 5A-5D are side views illustrating an exemplary method in accordance with the present disclosure for folding the external connector tabs and laser welding one of the internal terminals to the folded external connector tabs;

FIG. 6 is a perspective view illustrating laser welding of one of the internal terminals to the folded external connector tabs; and

FIG. 7 is a perspective view of an end of another stack of cathode electrodes, anode electrodes, and external connector tabs in accordance with the present disclosure.

In the drawings, reference numbers may be reused to identify similar and/or identical elements.

### DETAILED DESCRIPTION

While battery cells including laser welded internal terminals according to the present disclosure are shown in the context of electric vehicles, the battery cells including laser welded internal terminals can be used in stationary applications and/or other applications.

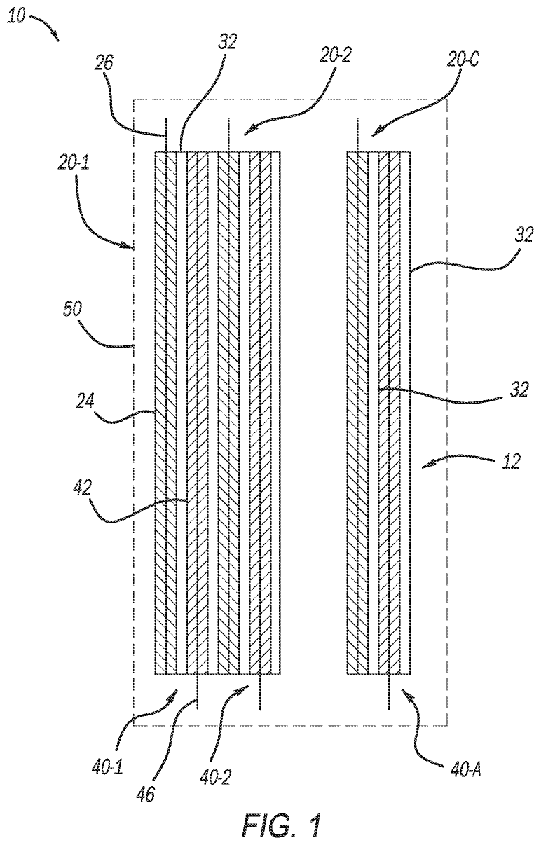

Referring now to FIG. 1, a battery cell 10 includes C cathode electrodes 20, A anode electrodes 40, and S separators 32 arranged in a predetermined sequence in a stack 12, which is seated in an enclosure 50. C, A, and S are integers, which are each greater than one. In some examples, A=C+1. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

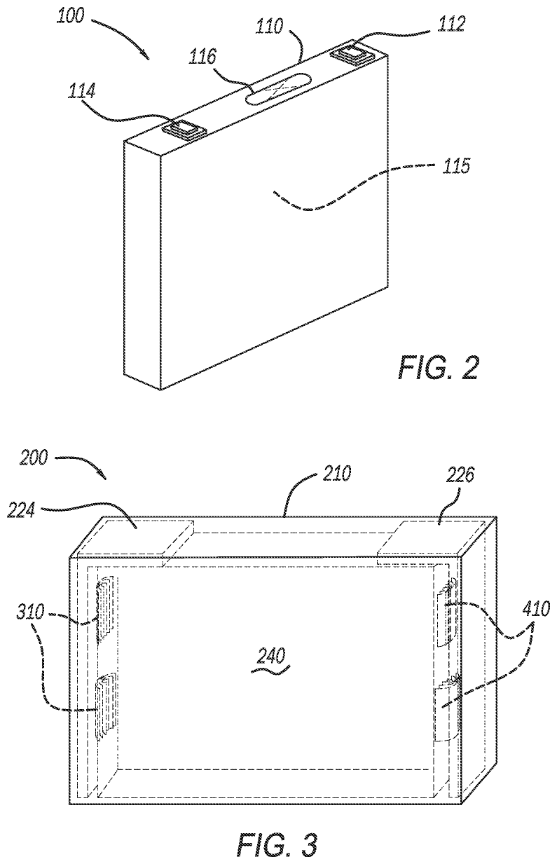

Referring now to FIG. 2, a prismatic battery cell 100 includes an enclosure 110. In some examples, the enclosure 110 has a rectangular cross-section. The prismatic battery cell 100 includes external terminals 112 and 114, and a vent cap 116. A stack 115 of the C cathode electrodes 20, the A anode electrodes 40, and the S separators 32 is arranged in the enclosure 110. As will be described further below, the anode current collectors 46 and/or the cathode current collectors 26 include external tabs that are laser welded to internal terminals contacting the external terminals 112 and 114 of the battery cell 10.

Referring now to FIG. 3, a prismatic battery cell 200 includes an enclosure 210 and internal terminals 224 and 226 arranged at opposite ends of the enclosure 210. A stack 240 of the C cathode electrodes, the A anode electrodes, and the S separators is arranged in the enclosure 210. The cathode current collectors and/or the anode current collectors include external connector tabs 310 and 410 that extend therefrom, respectively. The external connector tabs 310 and 410 are laser welded to inner surfaces of the internal terminals 224 and 226 respectively, as further described herein.

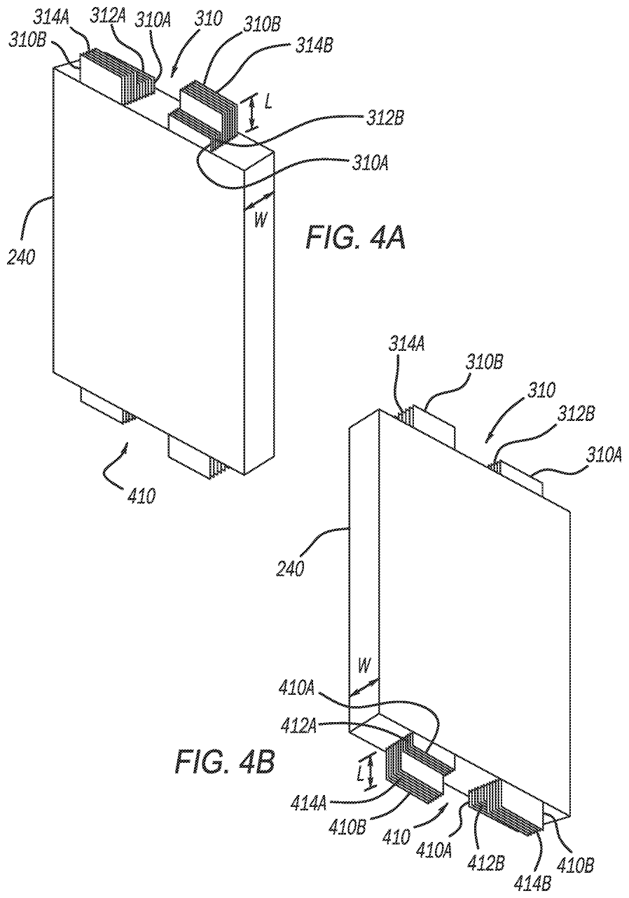

With additional reference to FIGS. 4A and 4B, the stack 240 is illustrated apart from the rest of the prismatic battery cell 200, and prior to the internal terminals 224 and 226 being welded to the external connector tabs 310 and 410 respectively. In the example of FIGS. 4A and 4B, the external connector tabs 310 include a plurality of first tabs 310A and a plurality of second tabs 310B. The plurality of second tabs 310B extend farther from the cathode current collectors 26 than the plurality of first tabs 310A. Thus, each one of the plurality of second tabs 310B is longer than each one of the plurality of first tabs 310A. With reference to FIG. 4A, for example, each one of the plurality of second tabs 310B has a length L that is less than, or equal to, half of a width W of the stack 240. As a result, when the plurality of second tabs 310B are folded onto the plurality of first tabs 310A in the manner described herein, the plurality of second tabs 310B will not extend beyond the width W of the stack 240.

The stack 240 includes at least two groups of the plurality of first tabs 310A, and at least two groups of the plurality of second tabs 310B. Each group of the plurality of first tabs 310A is adjacent to one of the groups of the plurality of second tabs 310B. For example, and as illustrated in FIG. 4A, the stack 240 includes a first group 312A of the plurality of first tabs 310A, which is adjacent to a first group 314A of the plurality of second tabs 310B. The stack 240 further includes a second group 312B of the plurality of first tabs 310A, which is adjacent to a second group 314B of the plurality of second tabs 310B. The first group 312A of the plurality of first tabs 310A is laterally spaced apart from, and aligned with, the second group 314B of the plurality of second tabs 310B. The first group 314A of the plurality of second tabs 310B is laterally spaced apart from, and aligned with, the second group 312B of the plurality of first tabs 310A. This staggered arrangement of the first and second groups 314A, 314B of the second tabs 310B ensures that second tabs 310B of each electrode (C cathode electrodes 20 and A anode electrodes 40), which are folded over the first tabs 310A as described herein, are welded to the internal terminals 224 and 226. The first groups 312A and 314A are laterally spaced apart from the second groups 312B and 314B in a direction perpendicular to a direction that the second tabs 310B are folded over the first tabs 310A, as described further herein.

The first group 314A of the plurality of second tabs 310B includes a number of the second tabs 310B that is equal to, or greater than, a number of the plurality of first tabs 310A included in the adjacent first group 312A. Similarly, the second group 314B of the plurality of second tabs 310B includes a number of the second tabs 310B that is equal to, or greater than, a number of the plurality of first tabs 310A included in the adjacent second group 312B. In some applications, the second tabs 310B may outnumber the adjacent first tabs 310A by as much as a factor of 3:2, for example.

With continued reference to FIGS. 4A and 4B, the external connector tabs 410 are configured in a manner similar to the external connector tabs 310, but at an opposite end of the stack 240. For example, the external connector tabs 410 include a plurality of first tabs 410A and a plurality of second tabs 410B. The plurality of second tabs 410B extend farther from the anode current collectors 46 than the plurality of first tabs 410A. Thus, each one of the plurality of second tabs 410B is longer than each one of the plurality of the first tabs 410A. With reference to FIG. 4B, for example, each one of the plurality of second tabs 410B has a length L that is less than, or equal to, half of a width W of the stack 240. The length L of the plurality of second tabs 410B is the same as, or substantially similar to, the length L of the plurality of second tabs 310B.

At the end of the stack 240 including the external anode connector tabs 410, are one or more groups of the plurality of first tabs 410A, and one or more groups of the plurality of second tabs 410B. Each group of the plurality of first tabs 410A is adjacent to one of the groups of the plurality of second tabs 410B. For example, and as illustrated in FIG. 4B, the stack 240 includes a first group 412A of the plurality of first tabs 410A, which is adjacent to a first group 414A of the plurality of second tabs 410B. The stack 240 further includes a second group 412B of the plurality of first tabs 410A, which is adjacent to a second group 414B of the plurality of second tabs 410B. The first group 412A of the plurality of first tabs 410A is laterally spaced apart from, and aligned with, the second group 414B of the plurality of second tabs 410B. The first group 414A of the plurality of second tabs 410B is laterally spaced apart from, and aligned with, the second group 412B of the plurality of first tabs 410A.

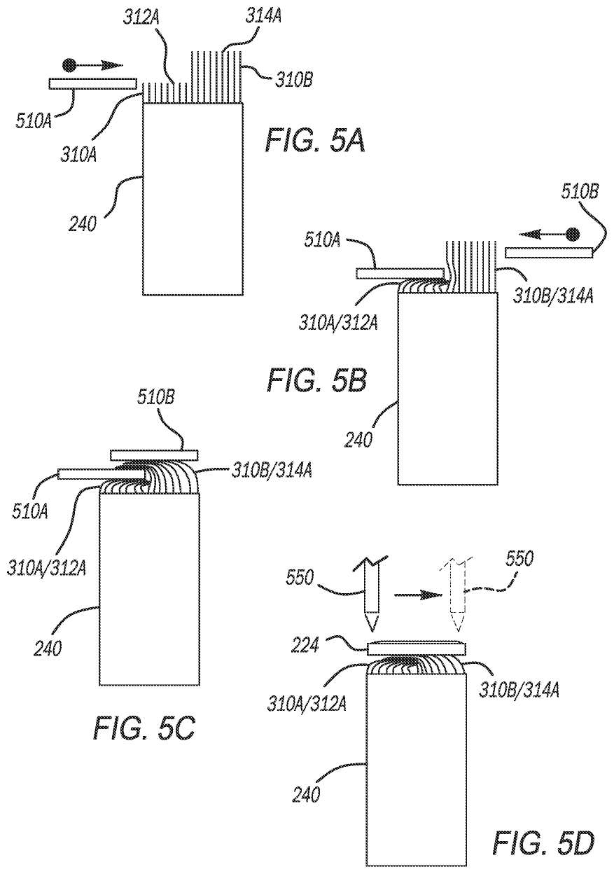

Prior to welding the internal (cathode) terminal 224 to the external (cathode) connector tabs 310, and prior to welding the internal (anode) terminal 226 to the external (anode) connector tabs 410, the external (cathode) connector tabs 310 and the external (anode) connector tabs 410 are folded. FIGS. 5A-5D illustrate an exemplary method in accordance with the present disclosure for folding the first group 312A of the plurality of first tabs 310A, and folding the first group 314A of the plurality of second tabs 310B. The method of FIGS. 5A-5D is also used to fold the other groups of the external connector tabs 310 and 410. More specifically, the method of FIGS. 5A-5D also applies to folding the second groups 312B/314B, the first groups 412A/414A, and the second groups 412B/414B. Any suitable number of additional groups of the external connector tabs 310 and 410 may be folded in accordance with the method of FIGS. 5A-5D. For example and as illustrated in FIG. 7, third groups 312C/314C and fourth groups 312D/314D may be folded and welded in accordance with the method of FIGS. 5A-5D, or any other suitable method.

As illustrated in FIG. 5A, the first group 312A of the plurality of first tabs 310A is folded in a first direction towards the first group 314A of the plurality of second tabs 310B using a first actuator 510A. The first actuator 510A may be any suitable device configured to fold the plurality of first tabs 310A in the first direction, such as any suitable automated actuation arm, panel, etc. FIG. 5B illustrates the first actuator 510A pressing against the first group 312A to fold the first group 312A in the first direction towards the first group 314A of the plurality of second tabs 310B.

With reference to FIG. 5C, after the first group 312A is folded, or simultaneous with the folding of the first group 312A, a second actuator 510B presses against, and folds, the first group 314A of the plurality of second tabs 310B towards the first group 312A in a second direction, which is opposite to the first direction. The second actuator 510B generally folds the first group 314A over and onto the first group 312A of the plurality of first tabs 310A. After the plurality of first tabs 310A are folded in the first direction, and the plurality of second tabs 310B are folded in the second direction over and onto the plurality of first tabs 310A, the first and second actuators 510A and 510B are removed. With reference to FIG. 5C, the L-shaped, internal terminal 224 is then seated on the first group 314A of the plurality of second tabs 310B and laser welded thereto.

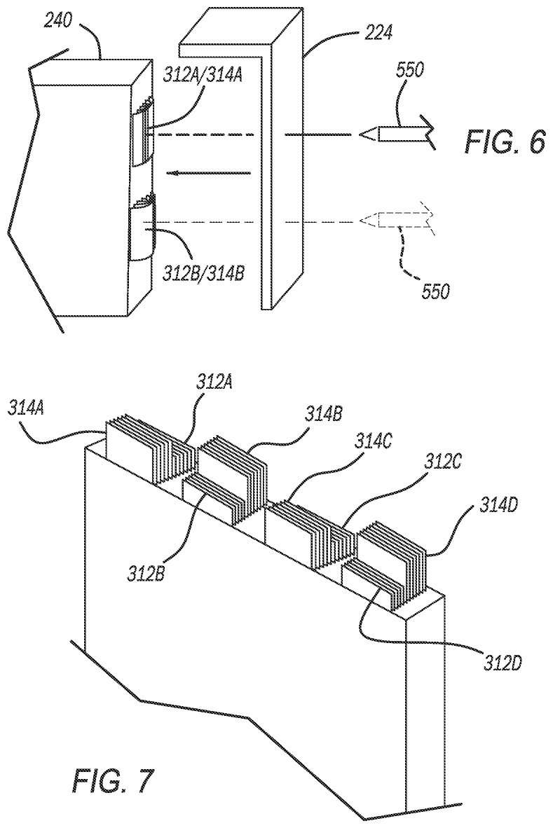

With additional reference to FIG. 6, the L-shaped, internal terminal 224 is also seated on the second group 314B of the plurality of second tabs 310B and laser welded thereto. The laser welding is performed with any suitable laser welding device 550. The laser welding device 550 is operated to weld the internal terminal 224 to the folded first and second groups 314A and 314B of second tabs 310B. The welds also weld together the plurality of second tabs 310B of the first group 314A, and weld together the plurality of second tabs 310B of the second group 314B. The welds may be made deep enough to weld the plurality of second tabs 310B to the plurality of first tabs 310A. The welds may extend still deeper to weld together the plurality of first tabs 310A of the first group 312A, and weld together the plurality of first tabs 310A of the second group 312B. The welds are confined to the connector tabs 310 and 410 so as to not extend to the separators 32. The L-shaped, internal terminal 226 is welded to the external connector tabs 410 in the same manner as described above with respect to the internal terminal 224.

Although the terminals 224 and 226 are illustrated as having an L-shape, they may have any other suitable shape as well. Furthermore, each one of the terminals 224, 226 may be made of a single piece or multiple connected pieces. For example, the terminals 224, 226 can each include a planar sheet that is welded to the folded external connector tabs 310 and 410 respectively. Subsequently, additional and relatively shorter planar portions may be welded to each of the planar sheets to provide each of the terminals 224 and 226 with the L-shape.

As referenced above, the stack 240 may include any suitable number of external connector tabs 310 and 410. In the example of FIG. 7, the stack 240 includes the first groups 312A/314A, the second groups 312B/314B, and the third groups 312C/314C. The stack 240 further includes the third groups 312C/314C, and the fourth groups 312D/314D. The stack 240 may include a similar arrangement of the external connector tabs 410 as illustrated in FIG. 7.

The present disclosure thus provides for a prismatic battery cell configuration that utilizes the maximum area of the battery cell can. Because the plurality of second tabs 310B/410B do not extend beyond the width W of the stack 240 when folded, there is no need for folding back and/or taping protruding tabs, which saves space. Folding the second tabs 310B/410B over the first tabs 310A/410A may reduce the overall dimensions of the prismatic battery cell 200. The plurality of first tabs 310A/410A provide a buffer for the welds to prevent the welds from reaching the separators 32. In situations where the welds do reach the plurality of first tabs 310A/410A, the plurality of first tabs 310A/410A may provide extra connections to pass current.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell, comprising:
a stack including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector; and
S separators, where C, A, and S are integers greater than one; and
a first internal terminal;
wherein each one of the external connectors, of one of the C cathode electrodes and the A anode electrodes, includes a first tab and a second tab extending farther than the first tab, the second tabs are folded onto the first tabs, and the first internal terminal is laser welded onto the second tabs.

2. The battery cell of claim 1, wherein N of the second tabs are folded onto R of the first tabs, N and R are integers with N being equal to or greater than R.

3. The battery cell of claim 1, wherein the first tabs are folded towards the second tabs.

4. The battery cell of claim 1, wherein each one of the second tabs has a maximum length that is less than, or equal to, half of a width of the stack.

5. The battery cell of claim 1, wherein:
a first group of the first tabs is adjacent to a first group of the second tabs, the first group of the second tabs is folded in a first direction onto the first group of the first tabs; and
a second group of the first tabs is adjacent to a second group of the second tabs, the second group of the second tabs is folded in a second direction onto the second group of the first tabs, the second direction is opposite to the first direction.

6. The battery cell of claim 5, wherein:
the first group of the first tabs is laterally spaced apart from, and aligned with, the second group of the second tabs in a third direction that is perpendicular to both the first direction and the second direction; and
the first group of the second tabs is laterally spaced apart from, and aligned with, the second group of the first tabs in the third direction.

7. The battery cell of claim 1, further comprising a second internal terminal:
wherein each one of the external connectors, of the other one of the C cathode electrodes and the A anode electrodes, includes a third tab and a fourth tab that is longer than the third tab, the fourth tabs are folded onto the third tabs, and the second internal terminal is laser welded onto the fourth tabs.

8. The battery cell of claim 7, wherein:
a first group of the third tabs is adjacent to a first group of the fourth tabs, the first group of the fourth tabs is folded in a first direction onto the first group of the third tabs; and
a second group of the third tabs faces a second group of the fourth tabs, the second group of the fourth tabs is folded in a second direction onto the second group of the third tabs, the second direction is opposite to the first direction.

9. The battery cell of claim 7, wherein the first internal terminal and the second internal terminal are on opposite ends of the stack.

10. The battery cell of claim 9, further comprising:
an enclosure;
a first external terminal in contact with the first internal terminal; and
a second external terminal in contact with the second internal terminal.

11. A battery cell, comprising:
a stack including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector; and
S separators, where C, A, and S are integers greater than one; and
a first internal terminal;
wherein with respect to one of the C cathode electrodes and the A anode electrodes, the external connectors include:
a plurality of first tabs and a plurality of second tabs extending farther than the plurality of first tabs;
a first group of the plurality of first tabs and a first group of the plurality of second tabs that is folded in a first direction onto the first group of the plurality of first tabs;
a second group of the plurality of first tabs and a second group of the plurality of second tabs that is folded in a second direction onto the second group of the plurality of first tabs, the second direction is opposite to the first direction; and
the first internal terminal laser welded onto the first group of the plurality of second tabs and the second group of the plurality of second tabs.

12. The battery cell of claim 11, wherein:
the first group of the plurality of first tabs is laterally spaced apart from, and aligned with, the second group of the plurality of second tabs; and
the first group of the plurality of second tabs is laterally spaced apart from, and aligned with, the second group of the plurality of first tabs.

13. The battery cell of claim 11, wherein:
the first group of the plurality of first tabs is folded toward the first group of the plurality of second tabs; and
the second group of the plurality of first tabs is folded towards the second group of the plurality of second tabs.

14. The battery cell of claim 11, further comprising a second internal terminal;
wherein with respect to the other one of the C cathode electrodes and the A anode electrodes, the external connectors include:
a plurality of first tabs and a plurality of second tabs extending farther than the plurality of first tabs;
a first group of the plurality of first tabs and a first group of the plurality of second tabs that is folded in a first direction onto the first group of the plurality of first tabs;
a second group of the plurality of first tabs and a second group of the plurality of second tabs that is folded in a second direction onto the second group of the plurality of first tabs, the second direction is opposite to the first direction; and
the second internal terminal laser welded onto the first group of the plurality of second tabs and the second group of the plurality of second tabs.

15. The battery cell of claim 11, wherein each one of the plurality of second tabs has a maximum length that is less than, or equal to, half of a width of the stack.

16. A method for manufacturing a battery cell, comprising:
providing a stack including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector;
a first group of a plurality of first tabs and a first group of a plurality of second tabs included with the external connectors of one of the C cathode electrodes and the A anode electrodes, the plurality of second tabs extending farther than the plurality of first tabs; and
S separators, where C, A, and S are integers greater than one;
folding the first group of the plurality of second tabs in a first direction onto the first group of the plurality of first tabs; and
laser welding a first internal terminal onto the first group of the plurality of second tabs.

17. The method of claim 16, further comprising folding the first group of the plurality of first tabs towards the first group of the plurality of second tabs in a second direction that is opposite to the first direction;
wherein subsequent to, or simultaneous with, folding the first group of the plurality of first tabs in the second direction, the first group of the plurality of second tabs is folded onto the first group of the plurality of first tabs.

18. The method of claim 16, further comprising:
providing the stack including a third group of a plurality of third tabs and a fourth group of a plurality of fourth tabs included with the external connectors of the other one of the C cathode electrodes and the A anode electrodes, the plurality of fourth tabs extending farther than the plurality of third tabs;
folding the fourth group of the plurality of fourth tabs onto the third group of the plurality of third tabs; and
laser welding a second internal terminal onto the fourth group of the plurality of fourth tabs.

19. The method of claim 18, further comprising folding the third group of the plurality of third tabs towards the fourth group;
wherein subsequent to folding the third group towards the fourth group, the fourth group is folded onto the third group.

20. The method of claim 16, wherein each one of the plurality of second tabs has a maximum length that is less than, or equal to, half of a width of the stack.
